(19) United States
(12) Patent Application Publication
(10) Pub. No.: US 2020/0196599 A1
(43) Pub. Date: Jun. 25, 2020

(54) INHIBITION OF EXOCYTOSIS AND THE USES THEREOF

(71) Applicant: Purdue Research Foundation, West Lafayette, IN (US)

(72) Inventor: Chunhua Zhang, West Lafayette, IN (US)

(73) Assignee: Purdue Research Foundation, West Lafayette, IN (US)

(21) Appl. No.: 16/718,293

(22) Filed: Dec. 18, 2019

Related U.S. Application Data
(60) Provisional application No. 62/781,820, filed on Dec. 19, 2018.

(51) Int. Cl. A01N 33/26; A01N 51/00

(52) U.S. Cl. CPC A01N 33/26; A01N 51/00

(57) ABSTRACT

The present application relates to a method for inhibiting exocytosis of a plant, fungi or a mammalian cells, in particular to inhibition of Exo70 proteins involved in exocytosis using a compound analogue of Endosidin2 (ES2). A composition matter comprising said compounds and methods of use are within the scope of the present invention.

### CROSS-REFERENCE TO RELATED APPLICATIONS

The present U.S. patent application is related to and claims the priority benefit of U.S. Provisional Patent Application Ser. No. 62/781,820, filed Dec. 19, 2018, the contents of which are hereby incorporated by reference in their entirety into the present disclosure.

### STATEMENT OF SEQUENCE LISTING

A computer-readable form (CRF) of the Sequence Listing is submitted with this application. The file, generated on Dec. 16, 2019, is entitled 68421-02_Seq_Listing_ST25_txt, the contents of which are incorporated herein in their entirety. Applicant states that the content of the computer-readable form is the same and the information recorded in computer readable form is identical to the written sequence listing.

### TECHNICAL FIELD

The present application relates to a method for inhibiting exocytosis of a plant, fungi or a mammalian cell, in particular to inhibition of Exo70 proteins involved in exocytosis using a compound analogue of endosidin2 (ES2). A composition matter comprising said compounds and methods of use are within the scope of the present invention.

### BACKGROUNDS AND SUMMARY OF THE INVENTION

This section introduces aspects that may help facilitate a better understanding of the disclosure. Accordingly, these statements are to be read in this light and are not to be understood as admissions about what is or is not prior art.

The fast expansion of human population significantly increases the demand for food and feed supply. With global hunger on the rise again, the Food and Agricultural Organization of the United Nations (FAO) has issued a sobering forecast on world food production. If global population reaches 9.1 billion by 2050, the FAO says that world food production will need to rise by 70%, and food production in the developing world will need to double. Crop protection and production plays essential role in feeding the world.

Exocytosis is a process by which proteins are released from a cell into the extracellular matrix. Newly synthesized proteins are incorporated into transport vesicles within the ER lumen, and these fuse with the cis-golgi. Cisternal migration progressively moves the transport vesicles towards the trans-golgi cisternae. Here, the vesicles move to and fuse with the plasma membrane, releasing the newly synthesized protein. Pharmacological inhibitors of vesicle trafficking possess great promise as valuable analytical tools for the study of a variety of biological processes and as potential therapeutic agents to fight microbial infections and cancer. However, many commonly used trafficking inhibitors are characterized by poor selectivity that diminishes their use in solving basic problems of cell biology, drug development, as well as crop protection for a better yield. The invention disclosed herein may find potential applications in agricultural industry as well as therapeutic uses for diseases caused by fungus infections.

### BRIEF DESCRIPTION OF DRAWINGS

FIG. 1A shows molecular structures of ES2 and analog 14. FIG. 4B shows representative images of 10 days old Arabidopsis seedlings grown on ½ MS media supplemented with 0.1% DMSO or different concentrations of ES2 and ES2 analog 14. Scale bars, 1 cm; FIG. 1C shows quantification on the root length of Arabidopsis seedlings grown on ½ MS supplemented with 0.1% DMSO or different concentrations of ES2 and ES2 analog 14 at different time points. FIGS. 1A-1C demonstrate that ES2 analog 14 is more efficient than ES2 in inhibiting Arabidopsis root growth.

FIG. 2A shows PIN2:GFP localization after 2-h treatment with DMSO or different concentrations of ES2 and analog 14; FIG. 2B shows quantification on the numbers of PVC that contain PIN2:GFP in root epidermal cells after 2-hour treatment with DMSO, ES2 or analog 14. Lower concentrations of analog 14 is required to cause PIN2 localization in PVC; FIG. 2C shows representative images of PIN2 localizations after 1-h 40 μM BFA treatment, and after 80 minutes of recovery from BFA treatment in ½ liquid MS with 0.1% DMSO, 40 μM ES2 or 40 μM analog 14; FIG. 2D shows quantification on the numbers of BFA compartments in Arabidopsis root epidermal cells after 80 minutes of recovery in ½ liquid MS with 0.1% DMSO, 40 μM ES2 or 40 μM ES2 analog 14. PIN2:GFP exocytic trafficking from BFA compartments is slower in the presencfe of ES2 analog 14. Scale bars in A and C, 10 μm. FIGS. 2A-2D demonstrate that ES2 analog 14 is more efficient than ES2 in inhibiting PIN2 trafficking.

FIG. 3A shows silver staining of proteins in DARTS assays for ES2 with purified AtEXO70A1; FIG. 3B shows quantification on the ratio of protein band intensity of AtEXO70A1 and BSA in DARTS assays with ES2; FIG. 3C shows thermophoresis binding curve of NT-647-labeled purified AtEXO70A1 with different concentrations of ES2; FIG. 3D shows silver staining of proteins in DARTS assays for ES2 analog 14 with purified AtEXO70A1. BSA was mixed together with AtEXO70A1 in DARTS assays as the protein control. DMSO was added to the reactions that did not contain ES2 or analog 14 as the solvent control; FIG. 3E shows quantification on the ratio of protein band intensity of AtEXO70A1 and BSA in DARTS assays with analog 14; Both ES2 and analog 14 protected AtEXO70A1, but not BSA, from degradation at 1:3000 dilution of 1 mg/ml pronase; FIG. 4F, Thermophoresis binding curve of NT-647-labeled purified AtEXO70A1 with different concentrations of analog 14. FIGS. 3A-3F demonstrate that ES2 analog 14 directly interacts with AtEXO70A1.

FIG. 4A shows representative images of M. oryzae grown on CM medium supplemented with 0.1% DMSO or different concentrations of ES2 or ES2 analog 14 for 12 days; FIG. 4B shows quantification on the diameter of M. oryzae colonies grown on CM medium supplemented with DMSO or different concentrations of ES2 or analog 14 as shown in FIG. 4A; FIG. 4C shows representative images of B. cinerea colonies grown on V8 medium supplemented with 0.1% DMSO or different concentrations of ES2 or analog 14 for 4 days; FIG. 4D shows quantification on the diameter of B. cinerea colonies grown on V8 medium supplemented with DMSO and different concentrations of ES2 and analog 14 as shown in C. Scale bars in A and C, 1 cm. FIGS. 4A-4D demonstrate that ES2 analog 14 inhibits the growth of B. cinerea and M. oryzae more efficiently than ES2. For FIG. 4B and FIG. 4D, * and ** indicate significant difference in compare with DMSO control by paired t-test. *, p<0.05. **, p<0.01.

FIGS. 5A, 5D, 5G, and 5J show silver staining of proteins in DARTS assays to test for direct interaction between ES2 and MoEXO70 (FIG. 5A), analog 14 and MoEXO70 (FIG. 5D), ES2 and BcEXO70 (FIG. 5G), and analog 14 and BcEXO70 (FIG. 5J). FIGS. 5B, 5E, 5H, and 5K show quantification on the intensity of silver stained protein bands in DARTS assays shown in A, D, G, J, respectively. ES2 did not significantly protect MoEXO70 or BcEXO70 from degradation by pronase, indicating ES2 did not bind to MoEXO70 or BcEXO70 in this assay. Analog 14 significantly protected both MoEXO70 and BcEXO70 from degradation by pronase at the dilutions of 1:3000 and 1:10000 of 1 mg/ml pronase, indicating analog 14 directly interacts with both MoEXO70 and BcEXO70 in this assay. FIGS. 5C, 5F, 5I, and 5L show thermophoresis binding curve of purified GFP-MoEXO70A1 or GFP-BcEXO70 with different concentrations of ES2 or analog 14. FIG. 5C, GFP-MoEXO70 with ES2. FIG. 5F, GFP-MoEXO70 with analog 14. FIG. 51, GFP-BcEXO70 with ES2. FIG. 5L, GFP-BcEXO70 with analog 14. * indicates significant difference in compare with BSA control by paired t-test, p<0.05. FIGS. 5A-5L show that analog 14 targets both MoEXO70 and BcEXO70.

FIG. 6A shows quantification on the effect of ES2 and analog 14 on M. oryzae appressoria formation. ES2 only slightly inhibited appressoria formation at 80 μM. Analog 14 inhibited the formation of appressoria at 10 μM or higher concentrations. FIG. 6B shows rice leaves inoculated with M. oryzae spores mixed with DMOS, ES2 or analog 14. FIG. 6C shows quantification on the size of lesions on rice leaves inoculated with M. oryzae spores mixed with DMSO, ES2 or analog 14. FIG. 6D shows that Arabidopsis leaves inoculated with B. cinerea spores mixed with DMSO, ES2 or analog 14. FIG. 6E shows quantification on the size of lesions on Arabidopsis leaves inoculated with B. cinerea spores mixed with DMSO, ES2 or analog 14. Scale bars in B and D: 1 cm. * and ** indicate significant difference by paired t-test. *, p<0.05. **, p<0.01. FIGS. 6A-6E depict that ES2 analog 14 reduces the pathogenicity of M. oryzae and B. cinerea more efficiently than ES2.

FIG. 7 shows ES2 Analog 14 does not disturb general membrane system. 7 days old HDEL:GFP, GOP1p:YFP, VHA1:GFP, POP6:GFP, PIP2A:GFP, and PGP4:GFP seedlings were treated with 0.1% DMSO or 40 μM ES2 analog 14 for 2 hours in liquid ½ MS media. Images were taken from the epidermal cells of Arabidopsis seedlings expressing different marker proteins in their root transition zone.

FIG. 8 shows Coomassie staining of proteins used in biochemical binding assays. Lane 1, ladder. Lane 2, SUMO-His-AtEXO70A1 used for DARTS assay. Lane 3, SUMO-His-BcEXO70 used for DARTS assay. Lane 4, SUMO-His-MoEXO70 used for DARTS assay. Lane 5, SUMO-His-GFP-BcEXO70 used for MST assay. Lane 6, SUMO-His-GFP-MoEXO70 used for MST assay. Lanes 7, SUMO-His-GFP used for MST assay.

FIG. 9 shows that ES2 analog 14 does not affect the cellular localization of rEXO70 in Hela cells. Hela cells transformed with GFP-rGFP and mCherry-Rab8 were treated with 0.1% DMSO, 40 μM ES2 or 40 μM ES2 analog 14 for 4-h.

FIG. 10 shows sequence alignment of AtEXO70A1, MoEXO70 and BcEXO70.

FIGS. 11A-11B show thermophoresis binding curve of purified Sumo-GFP with different concentrations of ES2 (11A) or analog 14 (11B). There is no direct interaction was detected between SUMO-GFP and ES2 or between SUMO-GFP and analog 14.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

In the present disclosure, the term “about” can allow for a degree of variability in a value or range, for example, within 20%, within 10%, within 5%, or within 1% of a stated value or of a stated limit of a range.

In the present disclosure, the term “substantially” can allow for a degree of variability in a value or range, for example, within 70%, within 80%, within 90%, within 95%, or within 99% of a stated value or of a stated limit of a range.

In this document, the terms “a,” “an,” or “the” are used to include one or more than one unless the context clearly dictates otherwise. The term “or” is used to refer to a nonexclusive “or” unless otherwise indicated. In addition, it is to be understood that the phraseology or terminology employed herein, and not otherwise defined, is for the purpose of description only and not of limitation. Any use of section headings is intended to aid reading of the document and is not to be interpreted as limiting. Further, information that is relevant to a section heading may occur within or outside of that particular section. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

In some illustrative embodiments, this present invention relates to a method for inhibiting exocytosis of a species comprising the step of
applying an effective amount of an inhibitor of exocytosis to said species,
together with one or more diluents, excipients or carriers.

In some illustrative embodiments, this present invention relates to a method for inhibiting exocytosis of a species as disclosed herein, wherein said inhibitor of exocytosis is endosidin2 (ES2), Analog 14, or a functional analog thereof.

In some illustrative embodiments, this present invention relates to a method for inhibiting exocytosis of a species as disclosed herein, wherein said species is a plant or a fungus.

In some illustrative embodiments, this present invention relates to a method for inhibiting exocytosis of a species as disclosed herein, wherein said fungus is Magnaporthe oryzae or Botrytis cinerea.

In some illustrative embodiments, this present invention relates to a method for inhibiting exocytosis of a species as disclosed herein, wherein said fungus is a fungus of a crop field or a fungus found on a fruit or vegetable.

In some illustrative embodiments, this present invention relates to a method for inhibiting exocytosis of a species as disclosed herein, wherein said crop is rice.

In some illustrative embodiments, this present invention relates to a method for inhibiting exocytosis of a species as disclosed herein, wherein said fruit is strawberry.

In some other illustrative embodiments, this present invention relates to a method for controlling and preventing the growth of a fungus comprising the step of applying an effective amount of an inhibitor of exocytosis, together with one or more diluents, excipients or carriers.

In some illustrative embodiments, this present invention relates to a method for controlling and preventing the growth of a fungus as disclosed herein, wherein said inhibitor of exocytosis is endosidin2 (ES2), Analog 14, or a functional analog thereof.

In some other illustrative embodiments, this present invention relates to a method for controlling and preventing the growth of a fungus as disclosed herein, wherein said method for controlling and preventing the growth of a fungus is for a crop plant, a vegetable or a fruit.

In some other illustrative embodiments, this present invention relates to a method for controlling and preventing the growth of a fungus as disclosed herein, wherein said crop plant is rice.

In some other illustrative embodiments, this present invention relates to a method for controlling and preventing the growth of a fungus as disclosed herein, wherein said fruit is strawberry.

In some other illustrative embodiments, this present invention relates to a method for controlling and preventing the growth of a fungus as disclosed herein, wherein said fungus is Magnaporthe oryzae or Botrytis cinerea.

In some other illustrative embodiments, this present invention relates to a composition for controlling and preventing the growth of a fungus comprising ES2 or Analog 14, or a functional analog thereof, together with one or more diluents, excipients or carriers.

In some other illustrative embodiments, this present invention relates to a composition for controlling and preventing the growth of a fungus comprising ES2 or Analog 14, or a functional analog thereof, and one or more other compounds of the same or different mode of action, together with one or more diluents, excipients or carriers.

In some embodiments, the composition matters may be formulated in various dosage forms, including, but not limited to, dry formulation, liquid formulation, granular or pellet formulation. The practice and information are known in the arts. In some other embodiments, the final product of the composition disclosed herein may be formulated as a suspension, a liquid spray, a powder, a nanoparticle, or an aerosol, together with one or more adjuvants, excipients or carriers.

In preparing a product for an end user, adjuvants, surfactants, anti-drifting agents, colorings, anti-freezing or other stabilizing chemicals may be included. An adjuvant is an additive (usually in relatively low amounts compared to the carrier) that improves or enhances application, performance, safety, storage, or handling of an active ingredient. Adjuvants include materials such as: Surfactants (spreaders, stickers, emulsifiers, wetting agents), which increase surface contact, reduce runoff, and increase penetration through leaf cuticle.

It is understood that, the herbicides disclosed herein can be applied to a field of a plant for weed control at the same time as a pre-formulated mixture, or applied individually as a separately pre-formulated product, consequentially or concurrently.

It is understood that, multiple application of said composition of herbicides may be needed in some cases in order achieve effective and efficient weed control for a field of a plant. As disclosed herein said plant is resistant to the herbicides applied.

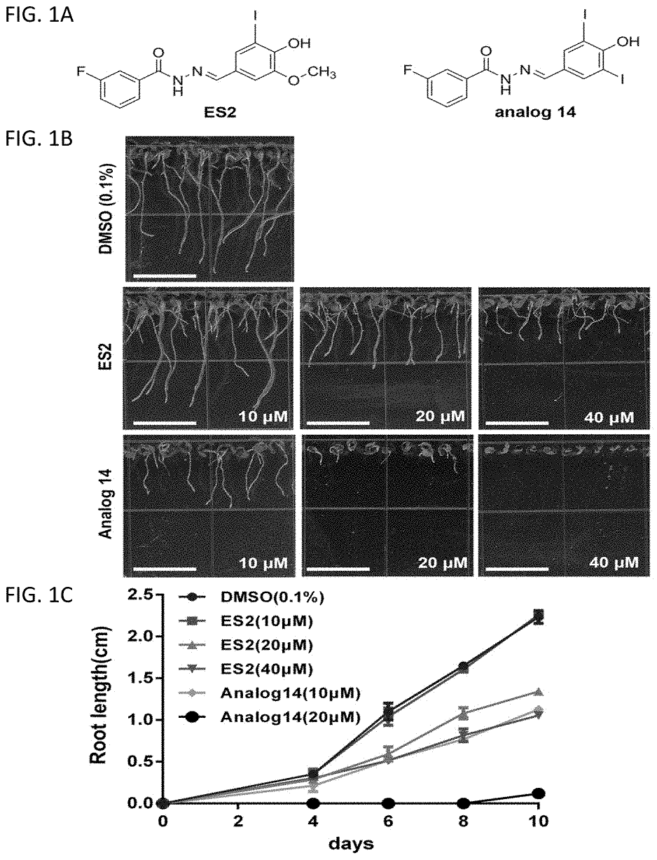

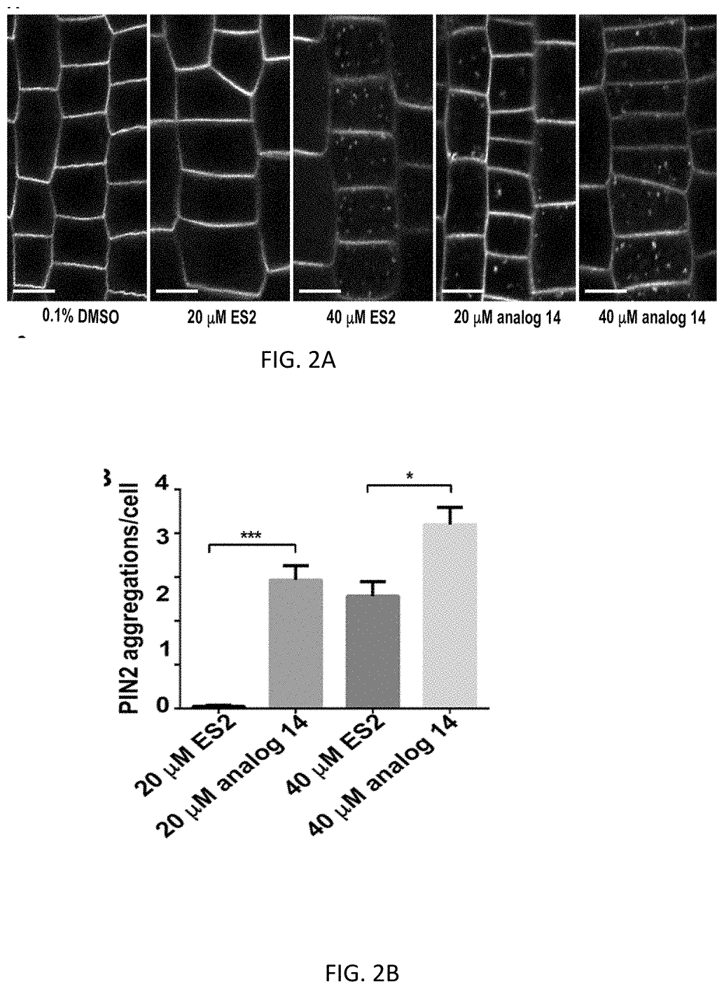

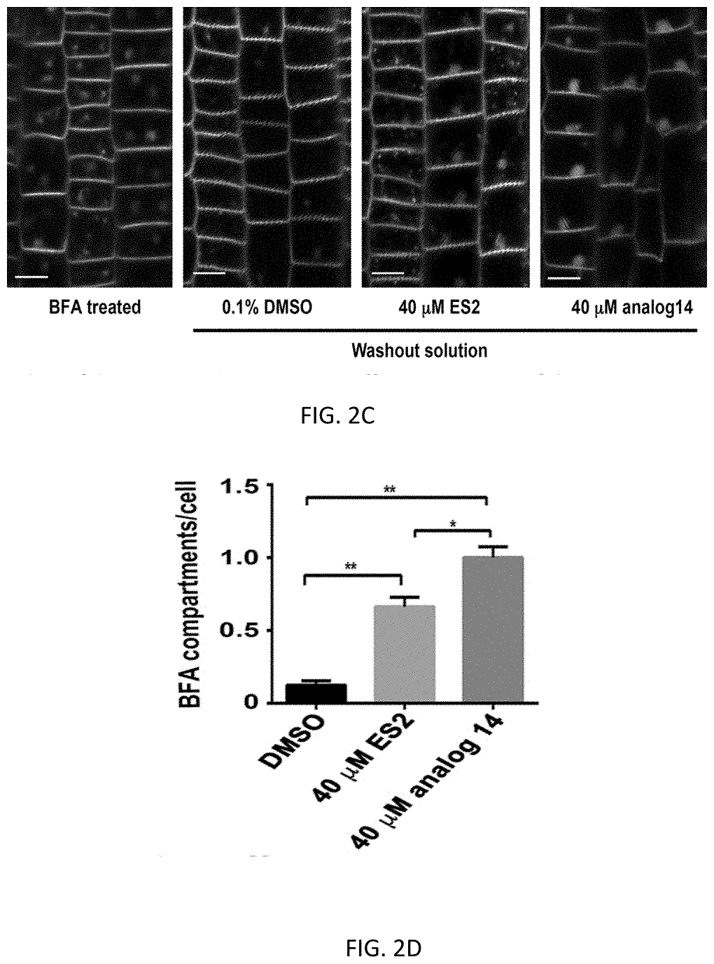

As it is disclosed herein, cellulo sin refers to a class of compounds that acts as an inhibitor toward cellulose synthase (CesA), an enzyme that catalyzes the synthesis of cellulose. Cellulosin was discovered as a potential herbicide, which is described in our provisional patent application No. 62/588,677, filed on Nov. 20, 2017, and the content of which is incorporated herein in its entirety. Recently, we found that Cellulosin has synergistic effect with isoxaben, a benzamide family of herbicide for preemergence control of broadleaf weeds. The known mutants that are resistant to isoxaben are sensitive to Cellulosin (FIG. 1). Most of our mutants that are resistant to Cellulosin are sensitive to isoxaben. This indicates that Cellulosin has different target site as isoxaben. We found that 300 nM Cellulosin or 3.5 nM isoxaben did not inhibit plant growth. However, combined application 300 nM Cellulosin and 3.5 nM isoxaben significantly inhibits plant growth (FIGS. 2A-2B). These results show that combined application of two herbicides at low concentration can be efficient in weed control. This method of herbicide application has at least two advantages. First, it reduces the cost of herbicides because lower dosage of each is needed. Second, because Cellulosin and isoxaben target different sites of the same group of plant proteins, combined application of both can reduce the chance of herbicide resistance development in weeds that is caused by repetitive application of the same herbicide. The method disclosed herein of applying both Cellulosin and isoxaben at the same time to a field of a plant for more efficient weed control.

The following non-limiting exemplary embodiments are included herein to further illustrate the invention. These exemplary embodiments are not intended and should not be interpreted to limit the scope of the invention in any way. It is also to be understood that numerous variations of these exemplary embodiments are contemplated herein.

Plant growth and development require dynamic regulation of membrane trafficking in spatiotemporal manner for material delivery and signaling purposes. Exocytosis is an important step of membrane trafficking process that delivers materials such as proteins and lipids to the plasma membrane and extracellular space. Some of the cargo proteins of exocytosis include enzymes for cell wall synthesis, transporters or receptors for hormone signaling, and proteins facilitate nutrient uptake during plant development. For example, PIN auxin transporters and BRI1 brassino steroid receptor are constitutively delivered to the plasma membrane through exocytosis and retrieved through endocytosis to maintain their polarity and abundance required for plant growth (Geldner et al., 2007, Kleine-Vehn et al., 2011, Drdova et al., 2013a, Luschnig and Vert, 2014). The conserved octameric exocyst complex is an essential component in exocytosis that tethers secretory vesicles to the site of membrane fusion (Wu and Guo, 2015, Heider and Munson, 2012). Each exocyst complex contains one molecule of EXO70, EXO84, SEC3, SEC5, SEC6, SEC8, SEC10 and SEC15 protein (TerBush et al., 1996, Guo et al., 1999). In plants, the exocyst complex has been found to function in embryo development, xylem development, root development, cell wall deposition, polarized growth, cell plate formation, hormone signaling and immune responses (Drdova et al., 2013b, Fendrych et al., 2010, Kulich et al., 2010, Stegmann et al., 2012, Synek et al., 2006, Zhang et al., 2013, Vukasinovic et al., 2017). The rice exocyst complex is involved in effector recognition during M. oryzae invasion and is essential for rice defense against insect invasion (Fujisaki et al., 2015, Guo et al., 2018).

The exocyst complex is also essential for the growth of some filamentous fungi and their pathogenicity to plants. The rice blast disease caused by the hemibiotrophic fungus Magnaporthe oryzae and grey mold disease caused by necrotrophic fungus Botrytis cinerea are two types of fungal diseases that cause significant losses in agriculture every year. Deletion of exocyst components from M. oryzae not only inhibits growth, but also affects effector delivery during its infection on rice (Giraldo et al., 2013, Chen et al., 2015, Gupta et al., 2015). The function of exocyst in B. cinerea is not well characterized but it seems BcEXO84 is required for its growth and pathogenicity (Giesbert et al., 2012). The detailed mechanisms of how exocytosis is regulated in pathogen and host cells during host-pathogen interactions are not well understood.

The dynamic of exocytosis process and the severity of phenotypes in loss of function exocyst mutants make inhibitors of exocyst complex valuable. Transient inhibition of exocyst allows direct manipulation of exocytosis without using genetic mutants. Previously, a small molecule endosidin2 (ES2) was found to target the AtEXO70A1 in Arabidopsis and EXO70 in mammalian cells to inhibit exocytosis (Zhang et al., 2016). Cellular localization of proteins that undergo constitutive exocytosis and endocytosis was affected by short-term ES2 treatments. For example, after two hours of 40 μM ES2 treatment, the PIN2 auxin transporter and BRI1 brassino steroid receptor were found to have reduced abundance at the plasma membrane and have increased abundance at the pre-vacuolar compartment (PVC) and the vacuole. ES2 also inhibits the trafficking of PIN2 from brefeldin A (BFA) induced large cellular compartments. The equilibrium dissociation constant (Kd) between AtEXO70A1 and ES2 was found to be between 250 and 400 μM, depending on the biochemical assays used. This inhibitor has been used as a tool not only in understanding plant exocytosis regulation but also in mammalian cell membrane trafficking and cancer biology (Mayers et al., 2017, O'Neill et al., 2018, Cole et al., 2018, Wang et al., 2017, Gomez-Escudero et al., 2017). Here we found that a close analog of ES2, analog 14, directly interacts with AtEXO70A1 and can inhibit plant exocytotis at a lower dosage in comparison with ES2. Analog 14 also directly interacts with MoEXO70 and BcEXO70 and inhibits the growth and pathogenicity of M. oryzae and B. cinerea. We expect that ES2 analog 14 could be a useful tool in investigating the mechanisms of plant and fungal exocytosis and the mechanisms of fungal pathogen and host interactions.

### Analog 14 is a More Potent Growth Inhibitor Than ES2

In a previous analysis on the structure-activity relationship of ES2, two analogs were found to be active in inhibiting the trafficking of PIN2 to the plasma membrane (Zhang et al., 2016). Analog 14 is one of these active analogs that have a minor structural difference from ES2 by replacing the methoxy group in one of the benzene rings with an iodine (FIG. 1A). To assay the effect of this modification on plant growth inhibition, Arabidopsis seedlings were grown on growth media supplemented with different concentrations of ES2, analog 14, or the DMSO solvent control. No obvious differences in growth were observed between 10-day-old seedlings grown on media with 10 μM ES2 or DMSO. However, Arabidopsis seedlings had significantly shorter roots when grown on growth media with 10 μM analog 14 than on media with DMSO. At the concentration of 20 μM or 40 μM, seedlings grown on media with analog 14 were significantly smaller and had shorter roots than those grown on media with the same concentration of ES2 (FIG. 1B). In fact, on growth media supplemented with 40 μM analog 14, the roots of Arabidopsis seedlings failed to elongate at all. Statistical analysis with the root length of seedlings grown on media with different concentrations of ES2 and analog 14 at various time points confirmed that analog 14 is a more potent growth inhibitor than ES2 (FIG. 1C).

### Analog 14 is Also a More Potent Inhibitor of Exocytosis in Arabidopsis than ES2

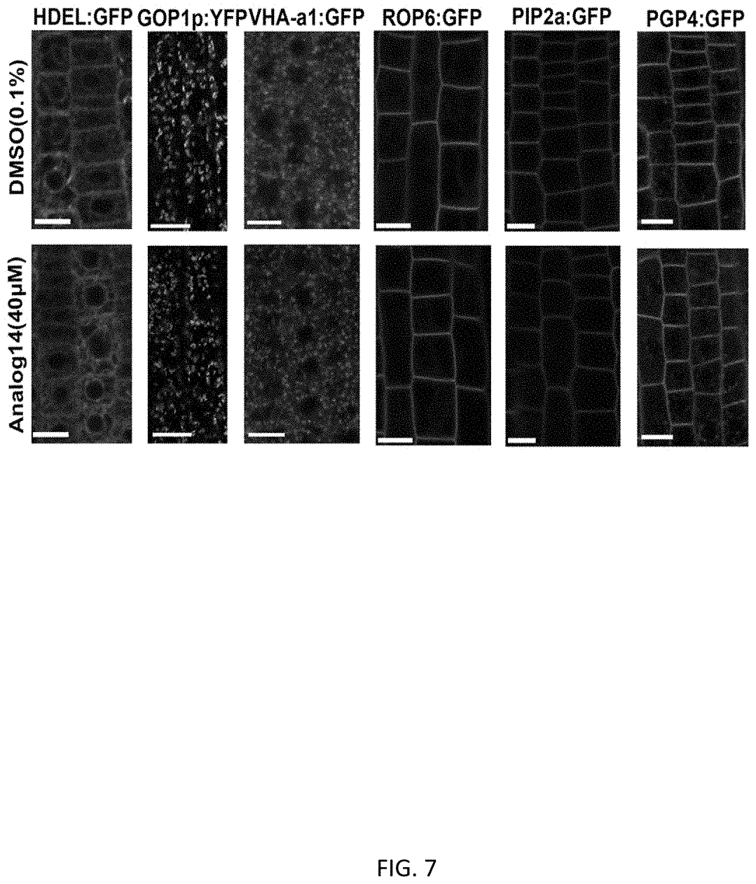

To test whether analog 14 has similar effects as ES2 on exocytic trafficking (Zhang et al., 2016), we first examined the cellular localization of different organelle markers upon analog 14 treatment. Treatments with analog 14 had no obvious effects on the localization of fluorescence-tagged Endoplasmic Reticulum (ER) resident protein HDEL, Golgi protein GOP1p, Trans-Golgi network (TGN) protein VHA-a1, and plasma membrane-localized proteins ROP6, PIP2a and PGP4 (FIG. 7). These data indicate that analog 14, like ES2, does not disturb the general membrane system.

We then compared the effects of analog 14 and ES2 on cellular localization of PIN2 that goes through exocytic and endocytic trafficking constitutively during normal plant growth (Kleine-Vehn et al., 2011, Drdova et al., 2013a). Whereas it is predominantly localized to the plasma membrane when treated with DMSO, PIN2-GFP was found to accumulate at the PVC after treatment with 40 μM ES2 for 2 h (Zhang et al., 2016). When treated with 20 μM ES2 for 2 h, there were only a few PVC compartments that contained PIN2:GFP (FIGS. 2A, 2B). However, treatment with 20 μM analog 14 for 2 h significantly increased the number of PVC compartments that contain PIN2:GFP in comparison with ES2 treatment (FIGS. 2A, 2B). The number of PVC compartments containing PIN2:GFP were similar between treatments with 20 μM analog 14 or 40 μM ES2 for 2 h. Nevertheless, treatments with 40 μM analog 14 for 2 h or longer further increased PVC with GFP fluorescence (FIGS. 2A, 2B). These data indicate that analog 14 is more potent than ES2 in affecting PIN2 localization.

BFA is a fungal lactone that inhibits exocytic trafficking of proteins such as PIN2 (Jasik et al., 2016). To assay the inhibitory effects of analog 14 on exocytic transport, 7-day-old PIN2::PIN2:GFP seedlings were pretreated with 40 μM BFA for 60 min (FIG. 2C) and then recovered in ½ MS liquid media containing 0.5% DMSO, 40 μM ES2, or 40 μM analog 14. After 80 minutes of recovery, Arabidopsis root epidermal cells were examined by confocal microscopy. In comparison with the DMSO control, ES2 or analog 14 treatment significantly reduced the recovery of cells from BFA treatment and we observed PIN2:GFP in BFA-induced compartments. In seedlings recovered in media with analog 14, the average number of PIN2:GFP containing compartments was about 1 per cell. Under the same conditions, only approximately 0.65 BFA-induced PIN2:GFP compartments per cell were observed in seedlings recovered in media with ES2 (FIG. 2C, 2D). These results indicate that analog 14 is more potent than ES2 in inhibiting PIN2 from BFA-induced compartments.

### AtEXO70A1 Directly Interacts with Analog 14

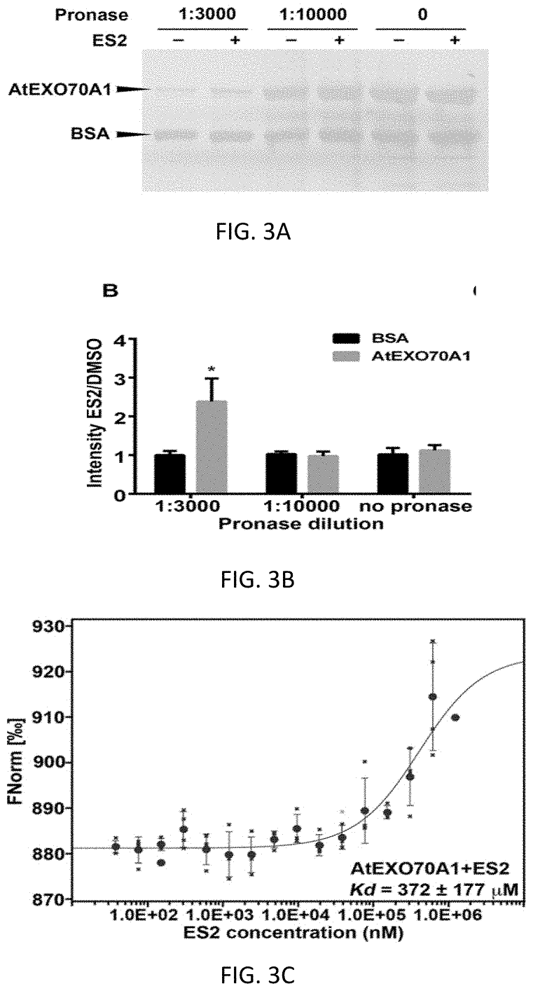

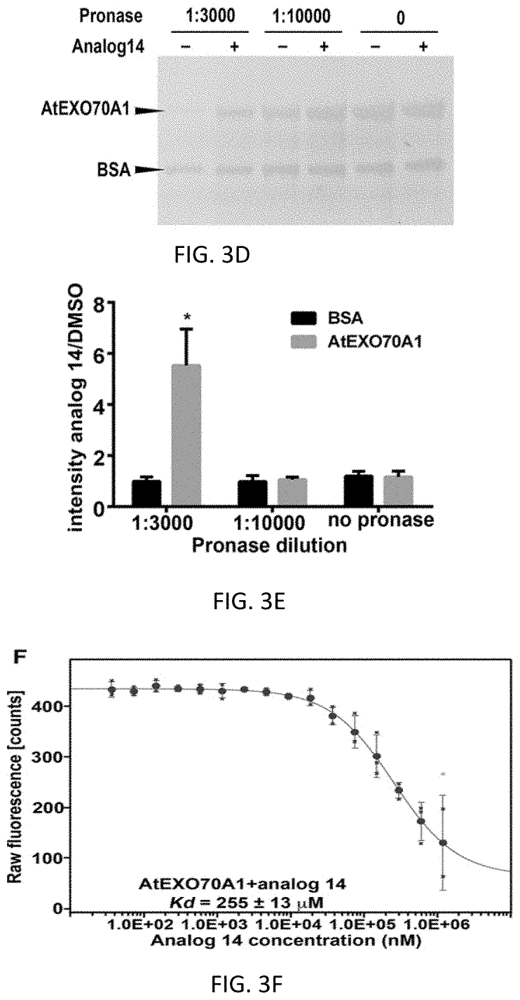

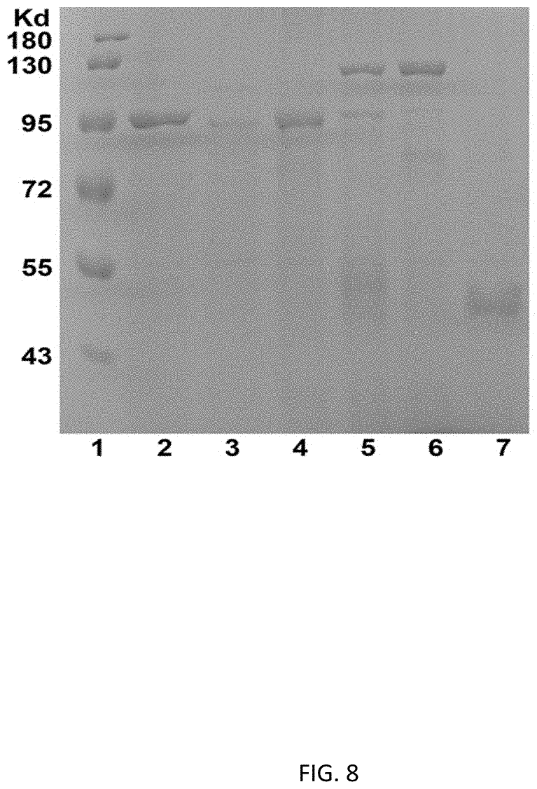

Because ES2 directly interacts with AtEXO70A1, a subunit of the exocyst complex (Zhang et al., 2016), we then assayed the interaction between analog 14 and AtEXO70A1. The full-length AtEXO70A1 protein fused with the SUMO-His tag was purified (FIG. 8, lane 2) and tested for its interaction with analog 14 and AtEXO70A1 using the drug affinity responsive target stability (DARTS) assay that is based on the protection of receptor proteins by ligands from degradation by proteases (Lomenick et al., 2009). Consistent with previous reports (Zhang et al., 2016), ES2 protected AtEXO70A1 from degradation by pronase, a mixture of different types of proteases, at 1:3000 dilution (FIGS. 3A, 3B). As an internal control for the DARTS assays, BSA was not protected by ES2 Similarly, analog 14 protected AtEXO70A1, but not BSA, from degradation (FIGS. 3D, 3E). These results showed that, like ES2, analog 14 can interact with AtEXO70A1 and protect it from degradation by proteases.

We next used the Microscale Thermophoresis (MST) assay to further test for the direct interaction between analog 14 and AtEXO70A1. AtEXO70A1 protein labelled with NT-647 (Zhang et al., 2016) were titrated with different concentrations of ES2 or analog 14 in MST assays. As previously reported (Zhang et al., 2016), ES2 interacted with AtEXO70A1 at a Kd of 372±177 μM (FIG. 3C). From the dosage responsive curve, analog 14 interacted with AtEXO70A1 at a Kd of 255±13 μM (FIG. 3F).

### ES2 and Analog 14 Differ in Inhibitory Activities on Exocytosis in Mammalian Cells

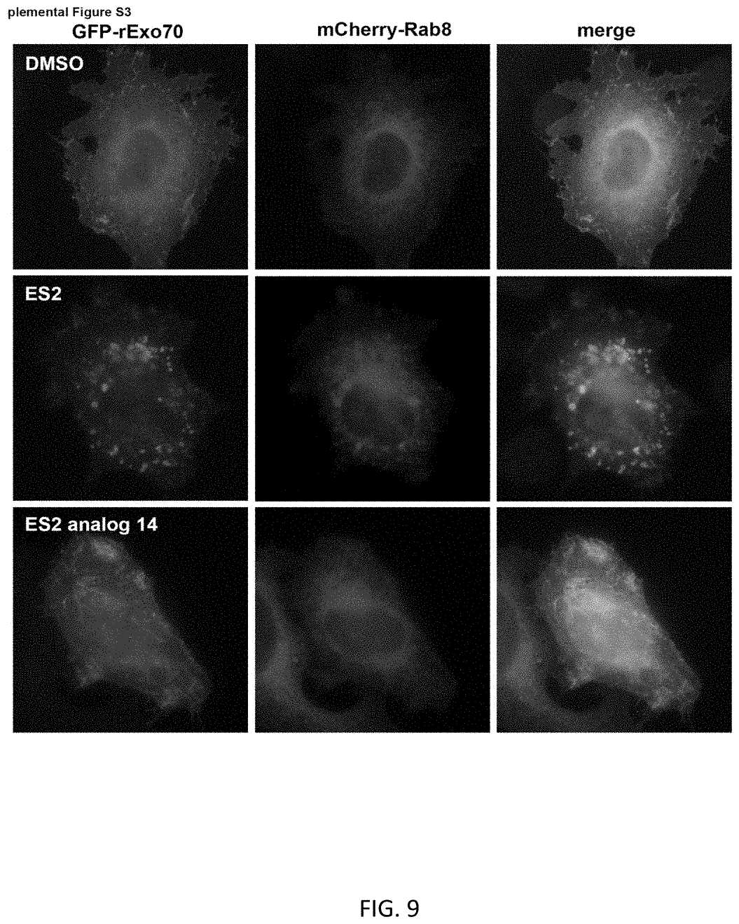

ES2 is active in targeting mammalian EXO70s and it can inhibit the recycling of transferrin and localization of rExo70 to the plasma membrane (Zhang et al., 2016). Because analog 14 interacts with AtEXO70A1, we then assayed whether it could be used as an exocytosis inhibitor in mammalian cells by testing its effects on the localization of GFP-rExo70 in Hela cells. Consistent with the earlier report (Zhang et al., 2016), ES2 reduced the localization of rExo70 to the plasma membrane and caused its accumulation in intracellular compartments containing Rabb (FIG. 9). However, the same dosage of analog 14 did not affect cellular localization of rExo70 in Hela cells (FIG. 9), indicating that analog 14 is not as potent as ES2 in inhibiting exocytosis in mammalian cells. Therefore, minor changes in ES2 structure could affect its specificity in targeting EXO70s in different organisms.

### Both M. oryzae and B. cinerea are More Sensitive to Analog 14 Than to ES2

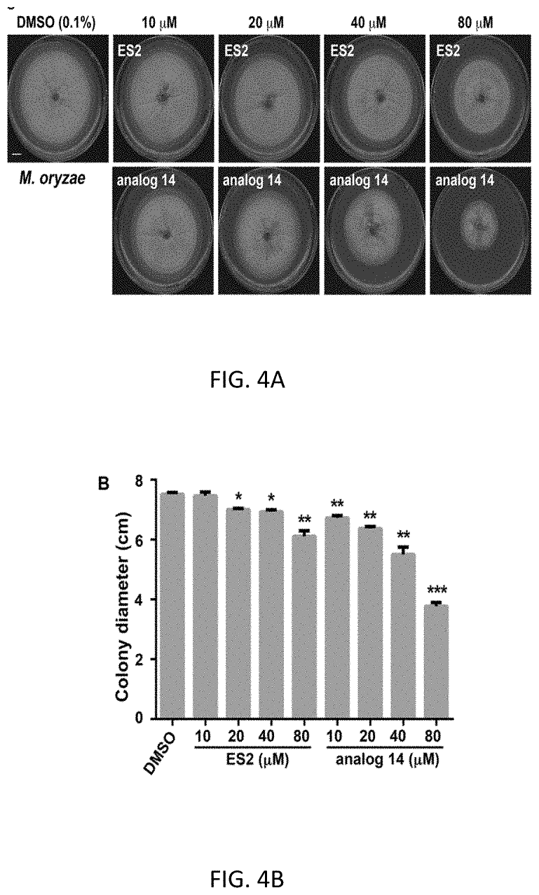

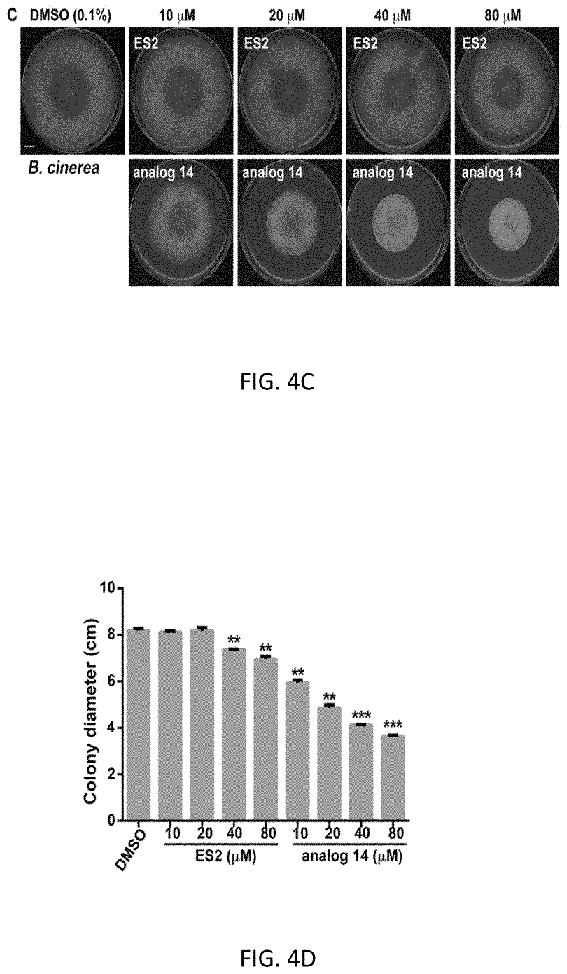

Because an inhibitor targeting the pathogen and host membrane systems with different efficiency will be a valuable tool in studying fungal-plant interactions, we then tested the effects of ES2 and analog 14 on M. oryzae and B. cinerea, two fungal pathogens with different infection mechanisms (Dean et al., 2012). When assayed for growth on media with different concentrations of ES2 and analog 14, we found that M. oryzae was more sensitive to analog 14 than to ES2 (FIG. 4A). Whereas 10 μM analog 14 was sufficient to cause significant reduction in growth, 20 μM ES2 or higher concentrations was necessary to significantly reduced the growth of M. oryzae (FIG. 4B). In B. cinerea, 40 μM of ES2 and 10 μM of analog 14 or higher concentrations significantly inhibited the growth rate of B. cinerea (FIG. 4C, 4D). In both M. oryzae and B. cinerea, a lower concentration of analog 14 than ES2 was required for reducing the growth rate approximately 50% (FIG. 4), indicating analog 14 is a more potent fungal growth inhibitor.

### Analog 14 Directly Interacts with MoEXO70 and BcEXO70

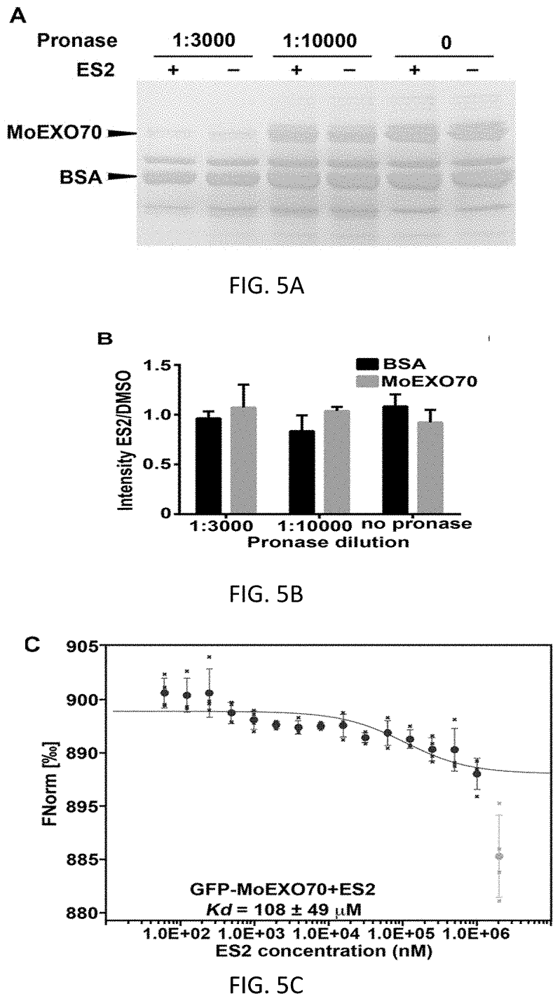

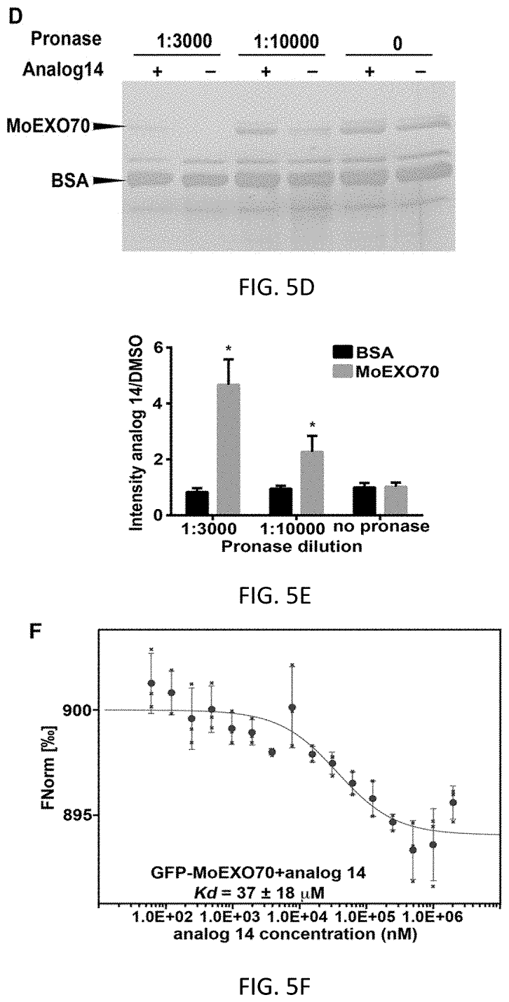

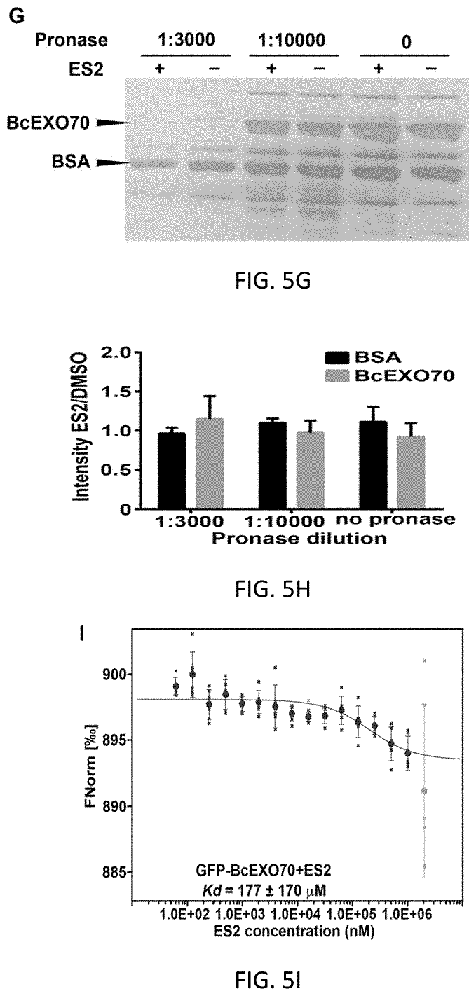

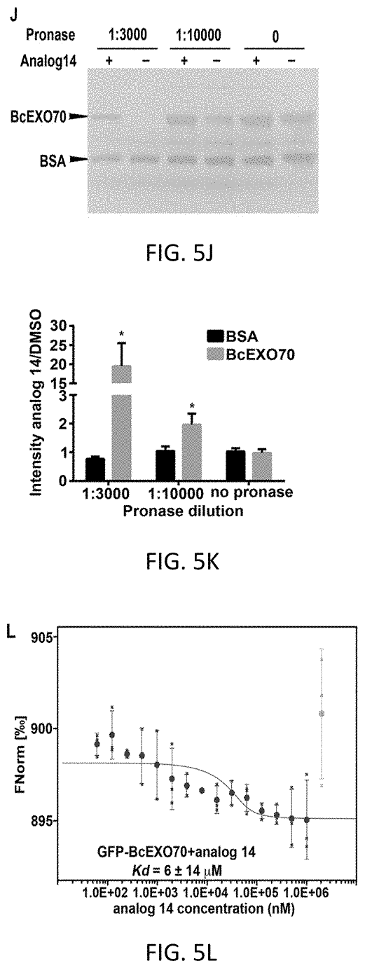

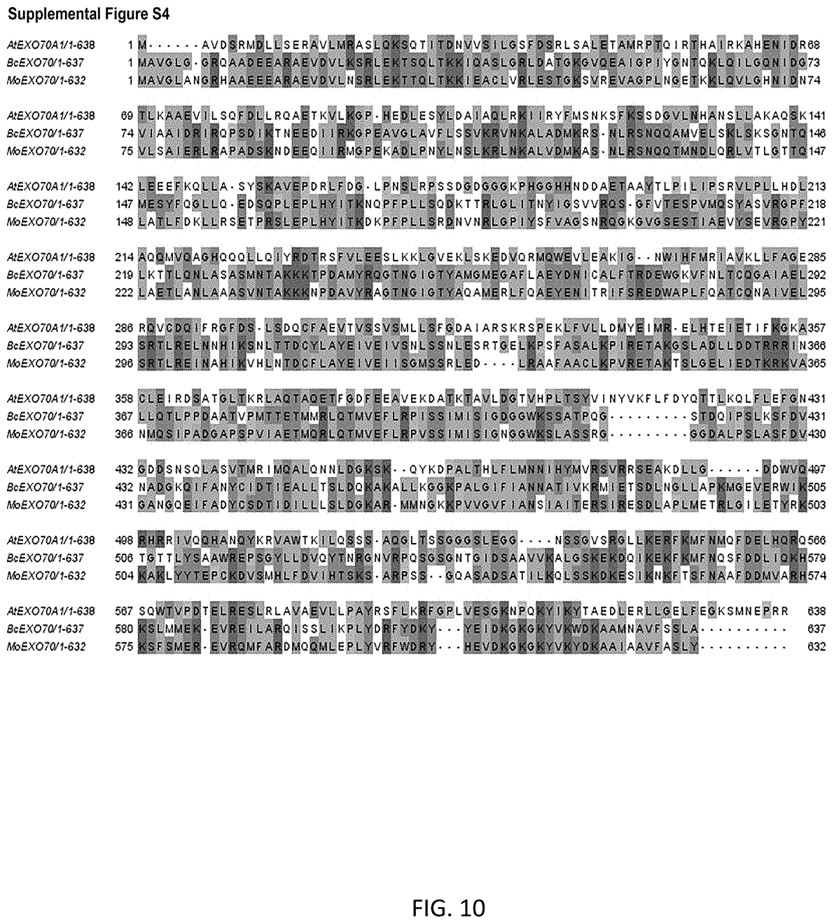

MoEXO70 and BcEXO70, the EXO70 orthologs in M. oryzae and B. cinerea, respectively, share 39% and 37% similarity to AtEXO70A1 in amino acid sequences (FIG. 10). To assay the inhibitory effect of ES2 and analog 14 on fungal EXO70 proteins, we expressed and purified MoEXO70 and BcEXO70 fused with the SUMO-His tag (FIG. 8, lanes 3 and 4, respectively). In DARTS assays, ES2 did not significantly protect MoEXO70 or BcEXO70 from degradation after pronase digestion at 1:3000 and 1:10000 dilutions (FIGS. 5A, 5B, 5G, 5H). However, analog 14 protected MoEXO70 and BcEXO70, but not BSA, from degradation at 1:3000 and 1:10000 dilutions of pronase (FIGS. 5D, 5E, 5J, 5I). After protease digestion, the abundance of MoEXO70 and BcEXO70 was significantly higher in reactions containing analog 14 than the DMSO control. These results indicate that analog 14 directly interacts with both MoEXO70 and BcEXO70 in DARTS assays.

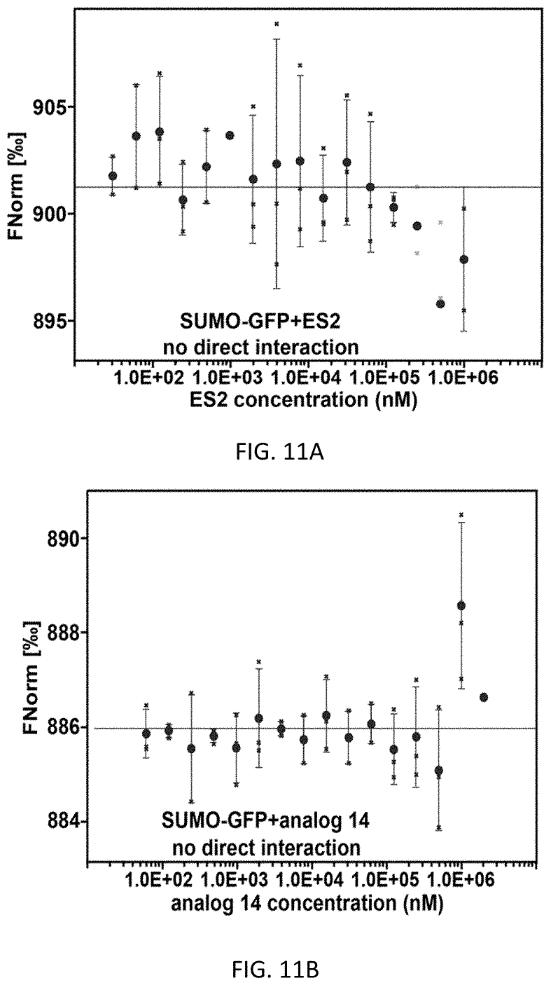

We then generated the GFP-MoEXO70 and GFP-BcEXO70 fusion proteins and assayed for their direct interaction with ES2 or analog 14 by the MST assay (FIG. 8, lanes 5 and 6, respectively). ES2 interacted with both GFP-MoEXO70 and GFP-BcEXO70, with calculated Kd of 108±49 μM and 177±170 μM, respectively (FIGS. 5F, 5L). Analog 14 also interacted with both GFP-MoEXO70 and GFP-BcEXO70, with calculated Kd of 37±18 μM and 6±14 μM, respectively (FIG. 5C, 5I). As the control for MST assays, the SUMO-GFP fusion protein (FIG. 8 lane 7) did not interact with ES2 or analog 14 (FIGS. 11A-11B). These MST experiments indicate that both ES2 and analog 14 directly interact with MoEXO70 and BcEXO70 but analog 14 is a more potent EXO70 inhibitor in both fungi.

### Analog 14 is Inhibitory to Appressorium Formation and Plant Infection in M. oryzae

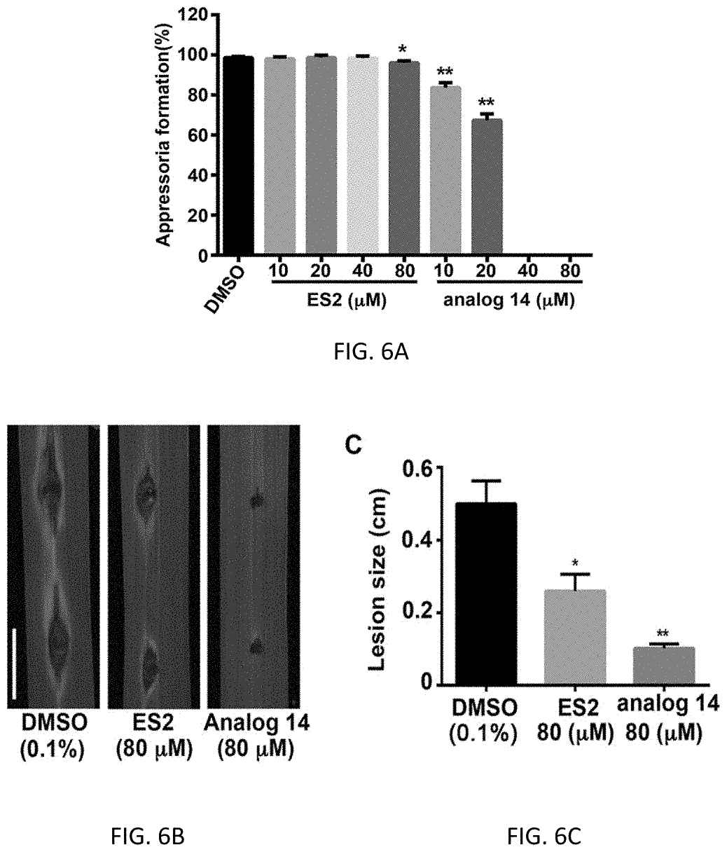

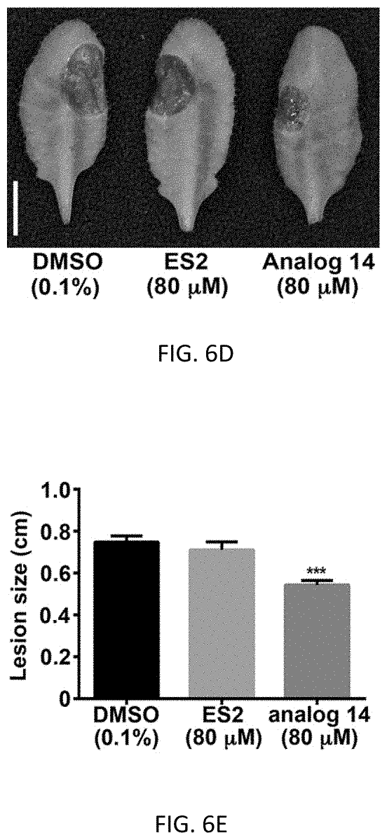

In M. oryzae, the formation of appressoria is essential for the establishment of infection on hosts. We first tested the effects of ES2 and analog 14 on the formation of appressoria on artificial hydrophobic surfaces. Different concentrations of ES2 or analog 14 were added to the spore suspensions. The formation of appressoria was observed after 24 hours of incubation under moist conditions. Whereas ES2 appeared to have limited effects, analog 14 was inhibitory to appressorium formation (FIG. 6A). Treatment with 10 μM analog 14 was sufficient to significantly reduce appressorium formation. Appressorium formation was almost completely blocked in the presence of 40 or 80 μM analog 14 (FIG. 6A).

We then mixed spores of M. oryzae with ES2 or analog 14 for infection assays with rice leaves. On leaves drop-inoculated with 4 μl spore suspensions with 80 μM analog 14, only limited necrosis was observed right below the spore drops at 6 days post-inoculation (dpi). No extensive spreading of typical blast lesions was observed in the presence of 80 μM analog 14 (FIGS. 6B; 6C). Leaves inoculated with spore suspensions with 80 μM ES2 also had smaller lesions in compare with the DMSO control (FIGS. 6B, 6C). These results indicate that ES2 and analog 14, particularly the latter, reduced the virulence of M. oryzae on rice leaves.

### Virulence of B. cinerea is Also Reduced by Analog 14

B. cinerea is a pathogen that could infect different plant species, including Arabidopsis. To test the effect of ES2 and analog 14 on the virulence of B. cinerea, we mixed its spores with 80 μM of ES2 or analog 14. On the leaves of three weeks old Arabidopsis plants inoculated with spore suspensions of B. cinerea, ES2 did not affect the development of lesions in comparison with the DMSO control. However, analog 14 significantly reduced the lesion size compared with the control (FIGS. 6D, 6E). These results showed that analog 14 is also a more potent inhibitor of fungal virulence in B. cinerea.

Proper operation of exocytosis is essential for cell growth, cell-cell communications and cell response to environments. During exocytosis process, exocyst complex tethers exocytic vesicles to the site of the plasma membrane for membrane fusion. In yeast cells, exocyst complex functions together with Rab GTPases signaling, actin cytoskeleton, and lipid signaling to regulate dynamic transport of proteins (Pleskot et al., 2015, Wu and Guo, 2015). The mechanisms of how plant exocyst functions are not well understood in plants and fungi. The pleiotropic phenotypes in loss of function exocyst mutants limit their applications in studying the dynamic exocytosis process. Previously, ES2 was found to inhibit exocytosis in plant and mammalian cells by targeting the EXO70 subunit of the conserved exocyst complex. ES2 directly interacts with AtEXO70A1 and rEXO70, although the two proteins only share 25% overall sequence identity. Due to the divergence of EXO70s in different organisms, minor modification on ES2 structure could affect its specificity on different EXO70s. In order to better use of ES2 and its analogs as exocytosis inhibitors in different organisms, we tested the effect of ES2 and its close analog, analog 14, on plant, mammalian cells and fungi.

We discovered that ES2 analog 14 inhibited Arabidopsis root growth and PIN2:GFP exocytosis at a lower dosage than ES2. Analog 14 directly interacted with AtEXO70A1 in DARTS and MST assays. The dissociation constant for analog 14 and AtEXO70A1 (255±13 μM) was slightly lower than that of ES2 and AtEXO70A1 (372±177 μM). These results show that analog 14 can be used as a potent exocyst inhibitor in Arabidopsis. However, analog 14 is not an efficient inhibitor for mammalian exocyst. Analog 14 did not cause the mis-localization of rEXO70 in Hela cells as that of ES2 with the dosage tested. We also tested the effect of ES2 and analog 14 on two types of fungal pathogens. We found that ES2 and analog 14 can inhibit the growth of both M. oryzae and B. cinerea. Lower dosage of analog 14 is required for the inhibitory effect on two types of fungi. We could not consistently detect direct interaction between ES2 and two fungal EXO70s using DARTS assay. However, we did find direct interaction between ES2 and two fungal EXO70s using MST assay. It could be that DARTS assay is more qualitative and cannot detect weak interactions. The biochemical interaction results are consistent with the weak inhibitory effect of ES2 on both fungi. However, direct interactions between analog 14 and two fungal EXO70s were detected in both DARTS and MST assays. Combine the cell growth assay and biochemical binding assays, we show that analog 14 is an exocyst inhibitor in M. oryzae and B. cinerea.

Exocytosis is not only essential for fungal growth, it also involves the establishment of invasion on host plants (Giraldo et al., 2013, Chen et al., 2015, Gupta et al., 2015). Analog 14 can efficiently inhibit the formation of appressorium in vitro. When we incubated the spores of M. oryzae and B. cinerea with analog 14 and then inoculated the host plants, the severity of disease development was reduced. This is consistent with findings from fungal genetic analysis that active exocytosis in fungal pathogen is required for their success in establishing host infection. We expect that analog 14 can be a useful inhibitor in understanding the regulation of exocytosis in fungal growth and pathogenicity.

To conclude, we disclosed herein an analog of a previously reported inhibitor of plant and mammalian EXO70. Using plant and fungal growth assay, we found that ES2 analog 14 is more potent in inhibiting Arabidopsis root growth and M. oryzae and B. cinerea hyphae growth. At the cellular level, analog 14 is more efficient in inhibiting PIN2:GFP exocytic trafficking. Analog 14 directly interacts with AtEXO70A1, MoEXO70 and BcEXO70. Consistent with previously reports using genetic mutants (Giraldo et al., 2013, Gupta et al., 2015, Martin-Urdiroz et al., 2016), inhibition of MoEXO70 using analog 14 reduces M. oryzae appressoria formation and its pathogenicity to rice. Combining biochemical binding assays, hyphal growth assay and pathogenicity test, we show BcEXO70 is essential for B. cinerea hyphal growth and its pathogenicity to Arabidopsis. We conclude that ES2 analog 14 can be used as an inhibitor in studying the mechanisms of plant and fungal exocytosis. Analog 14 can also be useful in studying the roles of exocytosis in fungal-plant interactions.

### Material and Methods

### Plant Material and Growth Conditions

To test the inhibitory effect of analog 14 on plant growth, Arabidopsis wildtype Col-0 seeds were used. To test the effect of analog 14 on cellular localization of proteins in different organelles, transgenic plants expressing fluorescence-tagged HDEL, GOP1p, VHA1-a1, ROP6, PIP2a and PGP4 were used (Cutler et al., 2000, Matsushima et al., 2003, Dettmer et al., 2006, Cho et al., 2007, Fu et al., 2009, Geldner et al., 2009). To test the effect of analog 14 on exocytic transport, PIN2::PIN2:GFP line was used (Xu and Scheres, 2005). Seeds for plants that were used for live cell imaging or growth assay were sequentially sterilized with 50% bleach and 75% ethanol. After washing with sterilized water, the seeds were sowed on ½ Murashige and Skoog (MS) growth media supplemented with 1% sucrose and 0.8% agar at pH 5.8. The plants were grown under continuously light of 130 μmol m⁻² s⁻¹ intensity at 22° C. To test the effect of ES2 and analog 14 on the pathogenicity of B. cinerea on Arabidopsis, wildtype Col-0 plants were grown in soil at 22° C. under a 16-h light and 8-h dark cycle. To test the effect of ES2 and analog 14 on the pathogenicity of M. oryzae on rice, rice cultivar Nipponbare was used and the plants were grown at 26° C. under 12-h light and 12-h dark cycle.

### Plant Growth Assay

In order to quantify the inhibitory effect of ES2 and analog 14 on Arabidopsis root growth, sterilized wildtype Col-0 seeds were sowed on ½ MS media supplemented with different concentration of ES2 or analog 14 on 10 cm×10 cm square petri dishes with grid. The plates were placed in vertical orientation in the growth chamber for root measurement. Starting from 4 days after the plates were placed in the growth chamber, the plates were scanned using Epson Perfection V550 scanner every two days. The root length of plants was measured using ImageJ. About 100 seedlings were measured from each treatment.

### Live Cell Imaging of Fluorescence-Tagged Proteins and Image Analysis

To test the effect of ES2 and analog 14 on cellular localization of fluorescence-tagged proteins, transgenic plants expressing different fluorescence-tagged proteins were grown on ½ MS agar plates for 5 days. The seedlings were incubated in ½ MS liquid media supplemented with different concentrations of ES2 or analog 14 for two hours. The images were collected using Zeiss 710 laser scanning confocal microscope equipped with a 40× water objective with NA1.2. For imaging GFP-tagged proteins, 488 nm laser line was used as excitation source and the emission light of 493-598 nm was collected. For imaging YFP-tagged proteins, 514 nm laser line was used as excitation source and the emission light of 519-621 nm was collected. The detailed procedure for ES2 and analog 14 treatment and BFA washout experiment can be found in published protocol (Huang and Zhang, 2018).

To quantify the intracellular localized PIN2 after ES2 and analog 14 treatment, Z-stack images from treated cells were thresholded and the cell outline was drawn using polygon selection tool in ImageJ. The intracellular pre-vacuolar compartments that contain PIN2:GFP were quantified using Analyze Particle tool in selected cells using imageJ. The compartments that are less than 0.1 μm² were considered as background and were discarded. A total of 8 images from about 90 cells were quantified for each drug treatment.

### Protein Expression and Purification

To obtain full length AtEXO70A1, MoEXO70 and BcEXO70 for DARTS assay, coding sequence of Arabidopsis EXO70A1, B. cinerea EXO70 and M. oryzae EXO70 were cloned from cDNA into modified pRSF-Duet-1 vector. To obtain GFP-labeled full length MoEXO70 and BcEXO70 protein for MST assay, pRSF-Duet-1 vector was further modified by inserting GFP coding sequence to the vector using EcoRI restriction site. Full length cDNA of MoEXO70 and BcEXO70 was cloned in frame to the C-terminal region of GFP to express the fusion protein using SacI and PstI sites. Primers used for cloning are listed in Table 1. Verified recombinant clones were transformed into BL21(DE3) competent cell for protein expression. The cells carrying expression plasmids were grown at 37° C. until OD600 reached 0.6 and then were induced for protein expression using 0.1 mM isopropyl β-D-1-thiogalactopyranoside (IPTG) at 16° C. After overnight incubation, the cells were lysed using sonication and the fusion protein was purified using a HisTrap HP histidine-tagged protein purification column in AKTA pure FPLC system (GE Healthcare, Pittsburgh, Pa.).

### Test the Effect of ES2 and Analog 14 on Fungal Growth

To test the effect of ES2 and analog 14 on the growth of B. cinerea, different concentrations of the compounds were added to V8 medium (36% V8 juice, 0.2% CaCO₃, 2% agar). To test the effect of ES2 and analog 14 on the growth of M. oryzae, complete medium (10 g/L D-Glucose, 2 g/L peptone, 1 g/L yeast extract, 1 g/L casamino acid, 1×nitrate salts, 1×vitamin and 15 g/L agar, pH 6.5) with different concentrations of the compounds were used. A 3-mm diameter block of culture from culture plate without compound was used to inoculate the plates with equal volumes of growth media and different concentrations of compounds. The inoculated cultures were grown at 22° C. under continuous fluorescence light. The culture plates were scanned with Epson Perfection V550 scanner and the diameters of colonies were measured 4 days after inoculation for B. cinerea and 12 days after inoculation for M. oryzae.

### Plant Infection Assays

For M. oryzae pathogenicity assay, microconidia harvested from complete medium agar cultures were resuspended to 5×10⁵ conidia/mL in sterile water containing 0.1% DMSO, 80 μM ES2 or 80 μM analog 14. Apply 4 μ1 suspension to two spots on each detached 2^{nd} leaf from 3-week-old rice plants. The inoculated leaves were kept in a culture dish containing 0.1% 6-Benzylaminopurine (6-BA) in dark for 24 hours and then transferred to the growth chamber under 12-hour/12-hour (light/dark) condition. The inoculated leaves were scanned at 6 days post inoculation and size of the lesions were measured using imageJ. For B. cinerea pathogenicity assay, conidia of strain B05.10 from V8 medium agar cultures were resuspended in 1% Sabouraud Maltose Broth containing 0.1% DMSO, 80 μM ES2 or 80 μM analog 14 to 1.25×10⁵ conidia/mL. 5 μL of the conidial suspension was applied to the surface of 3^{rd}, 4^{th} and 5^{th} leaves of 4-week-old Arabidopsis plants. The inoculated plants were kept under a transparent cover under continuous light at 22° C. The size of the lesions was measured 3 days after inoculation.

### DARTS Assay

To test the interaction between ES2 or analog 14 and EXO70 proteins, purified AtEXO70A1, MoEXO7O or BcEXO70 was used. 2.5 μg of purified protein was mixed with 2.5 μg of BSA in 200 μl reactions. The protein mixture was incubated with 2% DMSO, 400 μM ES2 or 400 μM analog 14 for 1 hour at room temperature with rotating. After incubation, each protein and chemical mixture was divided into 3 tubes. 1 μl pronase at 1:3000 or 1:10,000 dilutions from 10 mg/ml stock or 1 μl water was added to different aliquots. After 30 minutes of digestion, the reaction was terminated by adding SDS loading buffer and denaturing at 100° C. for 5 minutes. The samples were loaded to SDS-PAGE and the protein was detected using silver staining. The silver stained gel was scanned and the intensity of protein band was quantified using ImageJ.

### MST Assays

MST assays were carried out using a Monolith NT.115 (NanoTemper) at the Chemical Genomics Facility at Purdue University. To test the interaction between small molecules and AtEXO70, purified EXO70 with 74 amino acids deletion at the N-terminal region was labeled with NT-647 via amine conjugation (NanoTemper), which is the same as previously published (Zhang et al., 2016). To test the interaction between small molecules and MoEXO70 and BcEXO70, purified recombinant full length MoEXO70 and BcEXO70 with GFP-tag was used. SUMO-GFP was used for negative control MST experiments. Increasing concentrations of ES2 or analog 14 were titrated against 50 nM of the protein in a standard MST buffer (50 mM Tris, pH 7.5, 150 mM NaCl, 10 mM MgC12, 0.05% Tween 20). The small molecules were dissolved in DMSO and the final concentration of DMSO was 5% (vol/vol) with an equal volume of solution with target protein in all reactions. MST standard capillaries were used to load the samples to the MST instrument. At least three repeated reactions were performed for each test. The MST data was processed using MO. Affinity Analysis Version 2.3 software. We noticed that the interaction between analog 14 and NT-647 labeled AtEXO70A1 reduced the intensity of the fluorescence. The reaction curve was plotted using raw fluorescence and the concentration of analog 14 per recommendation from the manual.

### Detecting the Effect of Analog 14 on the Secretory Vesicles in Mammalian Cells

To test the effect of ES2 and analog 14 on the secretory vesicles in Hela cells, plasmids of rEXO70 and Rab8 was co-transfected to Hela cells. The cells were treated with 40 μM ES2 or analog 14 for 4 hours and the localization of rEXO70 and Rab8 was detected using Leica DMI6000 microscope.

TABLE 1
Primers used for cloning of EXO70s.

| SEQ | | |
|---|---|---|
| ID | | |
| NO: | Primer name | Primer sequence (5′-3′) |
| 1 | BcEXO70E-F | CGCGGATCCATGGCTGTGGGTTTAGGAGG |
| 2 | BcEXO70E-R | ATTTGCGGCCGCTCATGCCAAACTGGAGAATACA |
| 3 | MoEXO70E-F | CGCGGATCCATGGCTGTAGGCTTGGCTAA |
| 4 | MoEXO70E-R | ATTTGCGGCCGCTCAGTAAAGGCTGGCGAAAA |
| 5 | GFPBcEXO70- | AAACTGCAGATGGCTGTGGGTTTAGGAGG |
| | F | |
| 6 | GFPBcEXO70- | TAAGAATGCGGCCGCTCATGCCAAACTGGAGAAT |
| | R | ACA |
| 7 | GFPMoEXO70- | TAAGAATGCGGCCGCAATGGCTGTAGGCTTGGCT |
| | F | AA |
| 8 | GFPMoEXO70- | TAAGAATGCGGCCGCTCAGTAAAGGCTGGCGAAAA |
| | R | |
| 9 | AtEXO70A1F- | ttttttACCGGTATGGCTGTTGATAGCAGAATGGA |
| | F | |
| 10 | AtEXO70A1F- | ttttttCTCGAGCCGGCGTGGTTCATTCATAGACT |
| | R | |
| 11 | pRSF-GFP-F | AAAGAGCTCATGGTGAGCAAGGGCGAGGA |
| 12 | pRSF-GFP-R | AAACTGCAGCTTGTACAGCTCGTCCATG |

Those skilled in the art will recognize that numerous modifications can be made to the specific implementations described above. The implementations should not be limited to the particular limitations described. Other implementations may be possible.

While the inventions have been illustrated and described in detail in the drawings and foregoing description, the same is to be considered as illustrative and not restrictive in character, it being understood that only certain embodiments have been shown and described and that all changes and modifications that come within the spirit of the invention are desired to be protected. It should be understood by those skilled in the art that various alternatives to the embodiments described herein may be employed in practicing the claims without departing from the spirit and scope as defined in the following claims.

### REFERENCES CITED

1. CHEN, X., EBBOLE, D. J. & WANG, Z. 2015. Curr Opin Plant Biol, 28, 48-54.

2. CHO, M., LEE, S. H. & CHO, H. T. 2007. Plant Cell, 19, 3930-43.

3. COLE, R. A., et al., J Exp Bot, 2018, 69, 3625-3637.

4. CUTLER, S. R., EHRHARDT, D. W., GRIFFITTS, J. S. & SOMERVILLE, C. R. 2000. Proc Natl Acad Sci USA, 97, 3718-23.

5. DEAN, R., et al., Mol Plant Pathol, 2012, 13, 414-30.

6. DETTMER, J., HONG-HERMESDORF, A., STIERHOF, Y. D. & SCHUMACHER, K. 2006. Vacuolar H+-ATPase activity is required for endocytic and secretory trafficking in Arabidopsis. Plant Cell, 18, 715-30.

7. DRDOVA, E. J., SYNEK, L., PECENKOVA, T., HALA, M., KULICH, I., FOWLER, J. E., MURPHY, A. S. & ZARSKY, V. 2013a. The exocyst complex contributes to PIN auxin efflux carrier recycling and polar auxin transport in Arabidopsis. Plant J, 73, 709-19.

8. DRDOVA, E. J., SYNEK, L., PECENKOVA, T., HALA, M., KULICH, I., FOWLER, J. E., MURPHY, A. S. & ZARSKY, V. 2013b. The exocyst complex contributes to PIN auxin efflux carrier recycling and polar auxin transport in Arabidopsis. Plant J.

9. FENDRYCH, M., SYNEK, L., PECENKOVA, T., TOUPALOVA, H., COLE, R., DRDOVA, E., NEBESAROVA, J., SEDINOVA, M., HALA, M., FOWLER, J. E. & ZARSKY, V. 2010. The Arabidopsis exocyst complex is involved in cytokinesis and cell plate maturation. Plant Cell, 22, 3053-65.

10. FU, Y., XU, T., ZHU, L., WEN, M. & YANG, Z. 2009. A ROP GTPase signaling pathway controls cortical microtubule ordering and cell expansion in Arabidopsis. Curr Biol, 19, 1827-32.

11. FUJISAKI, K., ABE, Y., ITO, A., SAITOH, H., YOSHIDA, K., KANZAKI, H., KANZAKI, E., UTSUSHI, H., YAMASHITA, T., KAMOUN, S. & TERAUCHI, R. 2015. Rice Exo70 interacts with a fungal effector, AVR-Pii, and is required for AVR-Pii-triggered immunity. Plant J, 83, 875-87.

12. GELDNER, N., DENERVAUD-TENDON, V., HYMAN, D. L., MAYER, U., STIERHOF, Y. D. & CHORY, J. 2009. Rapid, combinatorial analysis of membrane compartments in intact plants with a multicolor marker set. Plant J, 59, 169-78.

13. GELDNER, N., HYMAN, D. L., WANG, X., SCHUMACHER, K. & CHORY, J. 2007. Endosomal signaling of plant steroid receptor kinase BRI1. Genes Dev, 21, 1598-602.

14. GIESBERT, S., SCHUMACHER, J., KUPAS, V., ESPINO, J., SEGMULLER, N., HAEUSER-HAHN, I., SCHREIER, P. H. & TUDZYNSKI, P. 2012. Mol Plant Microbe Interact, 25, 481-95.

15. GIRALDO, M. C., DAGDAS, Y. F., GUPTA, Y. K., MENTLAK, T. A., YI, M., MARTINEZ-ROCHA, A. L., SAITOH, H., TERAUCHI, R., TALBOT, N. J. & VALENT, B. 2013. Two distinct secretion systems facilitate tissue invasion by the rice blast fungus Magnaporthe oryzae. Nat Commun, 4, 1996.

16. GOMEZ-ESCUDERO, J., et al., J Cell Sci, 2017, 130, 4013-4027.

17. GUO, J., et al., Nat Genet, 2018, 50, 297-306.

18. GUO, W., GRANT, A. & NOVICK, P. 1999. Exo84p is an exocyst protein essential for secretion. J Biol Chem, 274, 23558-64.

19. GUPTA, Y. K., DAGDAS, Y. F., MARTINEZ-ROCHA, A. L., KERSHAW, M. J., LITTLEJOHN, G. R., RYDER, L. S., SKLENAR, J., MENKE, F. & TALBOT, N. J. 2015. Septin-Dependent Assembly of the Exocyst Is Essential for Plant Infection by Magnaporthe oryzae. Plant Cell, 27, 3277-89.

20. HEIDER, M. R. & MUNSON, M. 2012. Exorcising the exocyst complex. Traffic, 13, 898-907.

21. HUANG, L. & ZHANG, C. 2018. Use Endosidin2 to Study Plant Exocytosis and Vacuolar Trafficking. Methods Mol Biol, 1789, 167-175.

22. JASIK, J., BOKOR, B., STUCHLIK, S., MICIETA, K., TURNA, J. & SCHMELZER, E. 2016. Effects of Auxins on PIN-FORMED2 (PIN2) Dynamics Are Not Mediated by Inhibiting PIN2 Endocytosis. Plant Physiol, 172, 1019-1031.

23. KLEINE-VEHN, J., et al., Mol Syst Biol, 2011, 7, 540.

24. KULICH, I., COLE, R., DRDOVA, E., CVRCKOVA, F., SOUKUP, A., FOWLER, J. & ZARSKY, V. 2010. Arabidopsis exocyst subunits SEC8 and EXO70A1 and exocyst interactor ROH1 are involved in the localized deposition of seed coat pectin. New Phytol, 188, 615-25.

25. LOMENICK, B., HAO, R., et al., Proc Natl Acad Sci USA, 2009, 106, 21984-9.

26. LUSCHNIG, C. & VERT, G. 2014. The dynamics of plant plasma membrane proteins: PINs and beyond. Development, 141, 2924-38.

27. MARTIN-URDIROZ, M., OSES-RUIZ, M., RYDER, L. S. & TALBOT, N. J. 2016. Investigating the biology of plant infection by the rice blast fungus Magnaporthe oryzae. Fungal Genet Biol, 90, 61-68.

28. MATSUSHIMA, R., KONDO, M., NISHIMURA, M. & HARA-NISHIMURA, I. 2003. A novel ER-derived compartment, the ER body, selectively accumulates a beta-glucosidase with an ER-retention signal in Arabidopsis. Plant J, 33, 493-502.

29. MAYERS, J. R., HU, T., WANG, C., CARDENAS, J. J., TAN, Y., PAN, J. & BEDNAREK, S. Y. 2017. SCD1 and SCD2 Form a Complex That Functions with the Exocyst and RabE1 in Exocytosis and Cytokinesis. Plant Cell, 29, 2610-2625.

30. O'NEILL, P. R., CASTILLO-BADILLO, J. A., MESHIK, X., KALYANARAMAN, V., MELGAREJO, K. & GAUTAM, N. 2018. Membrane Flow Drives an Adhesion-Independent Amoeboid Cell Migration Mode. Dev Cell, 46, 9-22 e4.

31. PLESKOT, R., CWIKLIK, L., JUNGWIRTH, P., ZARSKY, V. & POTOCKY, M. 2015. Membrane targeting of the yeast exocyst complex. Biochim Biophys Acta, 1848, 1481-9.

32. STEGMANN, M., ANDERSON, R. G., ICHIMURA, K., PECENKOVA, T., REUTER, P., ZARSKY, V., MCDOWELL, J. M., SHIRASU, K. & TRUJILLO, M. 2012. The Ubiquitin Ligase PUB22 Targets a Subunit of the Exocyst Complex Required for PAMP-Triggered Responses in Arabidopsis. Plant Cell, 24, 4703-16.

33. SYNEK, L., et al., Plant J, 2006, 48, 54-72.

34. TERBUSH, D. R., MAURICE, T., ROTH, D. & NOVICK, P. 1996. The Exocyst is a multiprotein complex required for exocytosis in Saccharomyces cerevisiae. EMBO J, 15, 6483-94.

35. VUKASINOVIC, N., ODA, Y., PEJCHAR, P., SYNEK, L., PECENKOVA, T., RAWAT, A., SEKERES, J., POTOCKY, M. & ZARSKY, V. 2017. Microtubule-dependent targeting of the exocyst complex is necessary for xylem development in Arabidopsis. New Phytol, 213, 1052-1067.

36. WANG, Y., et al., PLoS Biol, 2017, 15, e2004310.

37. WU, B. & GUO, W. 2015. The Exocyst at a Glance. J Cell Sci, 128, 2957-64.

38. XU, J. & SCHERES, B. 2005. Dissection of Arabidopsis ADP-RIBOSYLATION FACTOR 1 function in epidermal cell polarity. Plant Cell, 17, 525-36.

39. ZHANG, C., BROWN, M. Q., et al., Proc Natl Acad Sci USA, 2016, 113, E41-50.

40. ZHANG, Y., et al., New Phytol, 2013, 199, 74-88.

What is claimed is:

1. A method for inhibiting exocytosis of a species comprising the step of applying an effective amount of an inhibitor of exocytosis to said species, together with one or more diluents, excipients or carriers.

2. The method according to claim 1, wherein said inhibitor of exocytosis is endosidin2 (ES2), Analog 14, or a functional analog thereof.

3. The method according to claim 1, wherein said species is a plant or a fungus.

4. The method according to claim 3, wherein said fungus is Magnaporthe oryzae or Botrytis cinerea.

5. The method according to claim 3, wherein said fungus is a fungus of a crop field or a fungus that infects a fruit or a vegetable.

6. The method according to claim 5, wherein said crop is rice.

7. The method according to claim 5, wherein said fruit is strawberry.

8. The method according to claim 3, wherein said plant is a weed.

9. The method according to claim 1, wherein said method is used for weed or fungus control of a crop field or a vegetable or fruit farm.

10. A method for controlling and preventing the growth of a fungus on a plant comprising the step of applying an effective amount of an inhibitor of exocytosis, together with one or more diluents, excipients or carriers.

11. The method according to claim 10, wherein said plant is a crop of grain or a fruit or vegetable.

12. The method according to claim 11, wherein said crop of grain is rice.

13. The method according to claim 11, wherein said fruit is strawberry.

14. The method according to claim 10, wherein said inhibitor of exocytosis is endosidin2 (ES2), Analog 14, or a functional analog thereof.

15. The method of claim 10, wherein said method for controlling and preventing the growth of a fungus is for a crop field, a vegetable farm, or a fruit farm.

16. The method of claim 15 wherein said crop is rice.

17. The method of claim 15, wherein said fruit is strawberry.

18. The method of claim 10, wherein said fungus is Magnaporthe oryzae or Botrytis cinerea.

19. A composition comprising ES2 or Analog 14, or a functional analog thereof, together with one or more diluents, excipients or carriers.

20. The composition of claim 14 further comprising one or more other compounds of the same or different mode of action.


SEQUENCE LISTING (12 sequences)

SEQ ID NO: 1 - DNA, 29 bp, artificial sequence
  primer BcEXO70F-F
cgcggatccatggctgtgggtttaggagg

SEQ ID NO: 2 - DNA, 34 bp, Artificial sequence
  primer BcEXO70F-R
atttgcggccgctcatgccaaactggagaataca

SEQ ID NO: 3 - DNA, 29 bp, Artificial sequence
  primer MoEXO70F-F
cgcggatccatggctgtaggcttggctaa

SEQ ID NO: 4 - DNA, 32 bp, Artificial sequence
  MoEXO70F-R
atttgcggccgctcagtaaaggctggcgaaaa

SEQ ID NO: 5 - DNA, 29 bp, artificial sequence
  primer GFPBcEXO70-F
aaactgcagatggctgtgggtttaggagg

SEQ ID NO: 6 - DNA, 37 bp, artificial sequence
  primer GFPBcEXO70-R
taagaatgcggccgctcatgccaaactggagaataca

SEQ ID NO: 7 - DNA, 36 bp, artificial sequence
  primer GFPMoEXO70-F
taagaatgcggccgcaatggctgtaggcttggctaa

SEQ ID NO: 8 - DNA, 35 bp, artificial sequence
  primer GFPMoEXO70-R
taagaatgcggccgctcagtaaaggctggcgaaaa

SEQ ID NO: 9 - DNA, 35 bp, Artificial sequence
  primer AtEXO70A1F-F
ttttttaccggtatggctgttgatagcagaatgga

SEQ ID NO: 10 - DNA, 35 bp, Artificial sequence
  primer AtEXO70A1F-R
ttttttctcgagccggcgtggttcattcatagact

SEQ ID NO: 11 - DNA, 29 bp, Artificial sequence
  primer pRSF-GFP-F
aaagagctcatggtgagcaagggcgagga

SEQ ID NO: 12 - DNA, 28 bp, Artificial sequence
  primer pRSF-GFP-R
aaactgcagcttgtacagctcgtccatg